(19) United States
(12) Patent Application Publication
(10) Pub. No.: US 2006/0252870 A1
(43) Pub. Date: Nov. 9, 2006

(54) Method for preparation of polyolefin nanocomposite

(75) Inventors: Ki-Do Lee, Seosan-si (KR); Jae-Whan Cho, Anyang-si (KR); Man-Saeng Her, Seosan-si (KR)

Correspondence Address: BARLOW, JOSEPHS & HOLMES, LTD., 101 DYER STREET, 5TH FLOOR, PROVIDENCE, RI, 02903, US

(73) Assignee: Samsung Total Petrochemicals Co., Ltd., Seosan-shi (KR)

(21) Appl. No.: 11/228,158

(22) Filed: Sep. 16, 2005

(30) Foreign Application Priority Data
Oct. 1, 2004 (KR) 10-2004-0078130

(51) Int. Cl. C08K 9/04

(52) U.S. Cl. 524/445; 524/543

(57) ABSTRACT

The present invention provides a method for preparation of polyolefin nanocomposite, specifically to a method in which polyolefin nanocomposite can be prepared in rather simple, efficient and economic way, through a single step without any pretreatment for modifying the polyolefin resin used as a matrix for the nanocomposite.

### TECHNICAL FIELD

The present invention relates to a method for preparation of polyolefin nanocomposite, specifically to a method in which polyolefin nanocomposite can be prepared in rather simple, efficient and economic way, through a single step without any pretreatment for modifying the polyolefin resin used as a matrix for the nanocomposite.

### BACKGROUND ARTS

Nanocomposite is a complex composition, wherein nanomaterials are dispersed in materials which form a matrix for the composite. Nanomaterials, owing to the characteristics that the particle size is in nanometer (nm) scale, have excellent physical properties and other effects which have never been expected from the conventional particles of micrometer (μm) scale size. Accordingly, nanocomposites which contain such nanomaterials have been received great attention because of their very good effects in various physical properties such as mechanical strength, heat resistance, flame resistance, gas barrier properties or the like. Thereupon, recently, nanotechnologies regarding nanomaterials and nanocomposites have been vigorously studied in domestic or other foreign researches.

As researches regarding nanotechnologies are actively progressed, many researches in not only the nanomaterials and nanocomposites themselves, but also the preparation method of nanomaterials or nanocomposites are being actively made. Particularly, in preparation of nanocomposites, the critical technique may be the formation of uniform dispersion of nanomaterials in a matrix material without deteriorating the intrinsic characteristics of the nanomaterials. Specifically in case of polyolefin nanocomposites, the dispersion of polar nanomaterials is basically difficult to be achieved, because of the lipophilicity of polyolefins which constitute the matrix. Therefore, there have been various attempts to overcome such problems and the results of such attempts have been known in this field.

Since the degree of dispersion of nanomaterial, particularly nanoclay, in polyolefin nanocomposite is the key factor to determine the characteristics of the final products, many conventional researches attempted to maximize the dispersion of nanoclay by using various methods including methods for reducing the polarity of nanoclay by organically modifying the nanoclay; methods for improving dispersability by swelling the nanoclay to increase its interlayer spacing, methods for improving the compatibility of polymers with nanoclay by grafting the matrix polymers, or the like.

U.S. Pat. No. 5,910,523 discloses a method for preparing a polypropylene composite wherein nanoclay is organically modified to improve the compatibility between the nanoclay and polymer. However, this method has a problem that the process for the modification of the clay is complicated, and has fundamental limitation that the dispersion of nanoclay cannot be sufficiently achieved only by such modification of the nanoclay.

Also, there have been other efforts to overcome such fundamental limitation in the modification of nanomaterials by modifying matrix polymers through a pretreatment.

Korean laid-open patent publication No. 2001-76519 discloses a technique for maximizing the dispersability of nanoclay by additional use of modified polypropylene resin grafted by a separate pretreatment of a polypropylene resin, as well as by the modification of the nanoclay. However, the separate pretreatment of a polypropylene resin makes the whole production process complicated and lowers the production efficiency, and since it requires additional cost and equipment for the pretreatment, it is not suitably applicable to practical industrial production in terms of production economy.

Therefore, development of techniques for preparing, in a simple, efficient and economic way, a polyolefin nanocomposite having superior or at least equivalent dispersability of nanomaterials to the polyolefin nanocomposite prepared by conventional methods has still been in great demand.

### DETAILED DESCRIPTION OF THE INVENTION

The present invention is to solve those problems of the conventional techniques, and thus to provide a method for preparing polyolefin nanocomposite having excellent dispersability of nanomaterials in simple, efficient and economic way, without requiring complicated and inefficient pretreatment processes as in conventional methods.

According to the present invention, provided is a method for preparation of polyolefin nanocomposite comprising a step of mixing polyolefin resin, nanomaterial, monomer for grafting and peroxide to disperse the nanomaterial and graft the monomer simultaneously.

The polyolefin resin used in the method according to the present invention is not specifically limited as long as they are suitable for the preparation of nanocomposites, and is preferably selected at least one from the group consisting of ethylene homopolymer resin, ethylene copolymer resin, propylene homopolymer resin, propylene copolymer resin and ethylene-vinylacetate copolymer resin. In the method according to the present invention, if necessary, it is possible to use modified polyolefin resins in addition to the polyolefin resin.

As for the nanomaterial used in the method according to the present invention, it is possible to use various materials with nanometer scale particle size according to the characteristics demanded in the resulted nanocomposite. Particularly, it is preferred to use nanoclay as the nanomaterial in the method according to the present invention, and more preferably, the nanoclay is at least one selected from the group consisting of montmorillonite, hectorite, saponite, nontronite, beidellite, vermiculite and halloysite, and has 1-50 nm of interlayer spacing in height, 1-20 microns of average particle size and 1-3 g/cc of density.

When nanoclay is used as the nanomaterial, the nanoclay is preferably a nanoclay organically modified with amine compound. When nanoclay is organically modified, it can be mixed better with resin components having strong lipophilicity since the polarity and thus hydrophilicity of the nanoclay become decreased, and as a result, the nanoclay can be more effectively dispersed in the matrix resin.

The amount of the nanomaterial used in the method according to the present invention may be varied depending on the characteristics demanded in the resulted nanocomposite, and it is preferred to use the polyolefin resin and the nanomaterial in the weight ratio of polyolefin resin: nanomaterial being 1:0.05-1:4, and more preferably 1:0.25-1:4.

The monomer for grafting used in the method according to the present invention is used to be grafted to some part of the polyolefin resin during mixing, with the purpose of modifying the hydrophilicity of the polyolefin resin and thus improving dispersion of the nanomaterial. The monomer for grafting is not specifically limited as long as it is generally used one in grafting of polyolefin resin, and preferred is maleic acid. The amount of the monomer for grafting may be varied depending on the species of monomer for grafting and the characteristics demanded in the resulted nanocomposite, but is preferably 0.05-5 parts by weight, based on 100 parts by weight of the polyolefin resin.

The peroxide used in the method according to the present invention is used as an initiator or a catalyst for the reaction of grafting the polyolefin resin with the monomer for grafting, and therefore those generally used for grafting polyolefin resins may be used without specific limitation. The amount of the peroxide may be varied depending on the characteristics demanded in the resulted nanocomposite, and is preferably 0.05-5 parts by weight, based on 100 parts by weight of the polyolefin resin.

In the method of the present invention, the polyolefin resin, the nanomaterial, the monomer for grafting and the peroxide are mixed in a way that dispersion of the nanomaterial and grafting of the monomer can be simultaneously occurred.

The mixing step in the method according to the present invention may be practiced under various conditions in various modes, according to the species and the amount of the polyolefin resin used, the species and the amounts of the nanomaterial used, the species of the monomer for grafting, the amount of the peroxide used and the characteristics required to the resulted nanocomposite. Particulary, the polyolefin resin, the nanomaterial, the monomer for grafting and the peroxide may be mixed preferably by melt-kneading in the temperature range of 150-250° C. The mixing step may be carried out by using mixing devices such as twin screw extruder, banbury mixer and the like.

In the method according to the present invention, within the scope of achieving the purposes of the present invention, one or more conventional additive generally used in conventional preparation of polyolefin nanocomposites such as an antioxidant, a heat stabilizing agent, a filler and the like, may be further added to and mixed with the polyolefin resin, the nanomaterial, the monomer for grafting and the peroxide.

In the method according to the present invention, it is possible to prepare a nanocomposite having additional physical properties other than that provided by the nanomaterial by additional treatment subsequent to the mixing step, or it is possible to provide the polyolefin nanocomposite prepared by the present invention as a master batch for other nanocomposite or resin composition and the like.

Hereinafter, the present invention is further described in detail through Examples and Comparative Examples given below, however it should be understood that the scope of the present invention is by no means limited by those examples.

### EXAMPLE 1

Polypropylene resin as the polyolefin resin, nanoclay as the nanomaterial, maleic acid as the monomer for grafting and peroxide were dry-mixed with the mixing ratio represented in Table 1 given below, and pelletized by a twin screw extruder at the die temperature of about 200° C. to obtain a polyolefin nanocomposite which contains about 40 wt % of nanoclay. Using the resulted polyolefin nanocomposite as a master batch, another polyolefin nanocomposite having the content of nanoclay of about 6 wt % for physical properties measurement was prepared by mixing the nanocomposite master batch and a polypropylene resin at the weight ratio of nanocomposite master batch polypropylene resin being 15:85. With thus obtained polyolefin nanocomposite for physical properties measurement, a test sample for the measurement was prepared, and the resulted test sample was applied to each test for determining tensile strength (ASTM D-638), flexural modulus (ASTM D-790) and Izod impact strength (23° C., ASTM D-256). The results of the measurement were represented in Table 1 below.

### EXAMPLE 2

A polyolefin nanocomposite was prepared by the same method as in Example 1, except that the components were melt-kneaded with the mixing ratio represented in Table 1 by using a banbury mixer at the set temperature of 160° C., and pelletized by using a twin screw extruder at the die temperature of 200° C. Using the resulted polyolefin nanocomposite as a master batch, another polyolefin nanocomposite for physical properties measurement was prepared and then a test sample for the measurement was prepared by the same method as in Example 1. Physical properties represented in Example 1 were also measured by the same method as in Example 1. The results of the measurement were represented in Table 1.

### COMPARATIVE EXAMPLE 1

By using the components, one of which was a modified polypropylene resin which had been grafted with maleic acid by pretreatment, represented in Table 1 with the mixing ratio represented in Table 1, a polyolefin nanocomposite for physical properties measurement was prepared and then a test sample for the measurement was prepared by the same method as in Example 1, and the physical properties represented in Example 1 were determined by the same method as in Example 1. The results of the measurement were represented in Table 1.

### COMPARATIVE EXAMPLE 2

By using the components represented in Table 1 with the mixing ratio represented in Table 1, a polyolefin nanocomposite for physical properties measurement was prepared and then a test sample for the measurement was prepared by the same method as in Example 1, and the physical properties represented in Example 1 were determined by the same method as in Example 1. The results of the measurement were represented in Table 1.

### COMPARATIVE EXAMPLE 3

By using the components, one of which was a modified polypropylene resin which had been grafted with maleic acid by pretreatment, represented in Table 1 with the mixing ratio represented in Table 1, a polyolefin nanocomposite for physical properties measurement was prepared and then a test sample for the measurement was prepared by the same method as in Example 2, and the physical properties represented in Example 1 were determined by the same method as in Example 1. The results of the measurement were represented in Table 1.

### COMPARATIVE EXAMPLE 4

By using the components represented in Table 1 with the mixing ratio represented in Table 1, a polyolefin nanocomposite for physical properties measurement was prepared and then a test sample for the measurement was prepared by the same method as in Example 2, and the physical properties represented in Example 1 were determined by the same method as in Example 1. The results of the measurement were represented in Table 1.

TABLE 1

| | | Examples | | Comparative Examples | | | |
|---|---|---|---|---|---|---|---|
| | | 1 | 2 | 1 | 2 | 3 | 4 |
| Components | PP | 60 | 60 | 30 | 60 | 30 | 60 |
| and content | Modified PP | — | — | 30 | — | 30 | — |
| thereof(parts | Nanoclay | 40 | 40 | 40 | 40 | 40 | 40 |
| by weight) | Maleic acid | 0.3 | 0.3 | — | — | — | — |
| | Peroxide | 0.27 | 0.27 | — | — | — | — |
| Physical | Tensile strength (kgf/cm²) | 428 | 430 | 439 | 416 | 451 | 425 |
| properties | Flexural modulus(kgf/cm²) | 24930 | 25520 | 25000 | 22500 | 25600 | 23100 |
| | Izod impact strength | 4.12 | 4.31 | 3.95 | 3.51 | 4.10 | 3.61 |
| | (kg · cm/cm) | | | | | | |

Note)
PP: Polypropylene; Product name H1500P manufactured by Samsung-Atofina
Modified PP: Polypropylene modified with maleic acid and peroxide; Product name CP4673 manufactured by Samsung-Atofina
Nanoclay: Organically modified montmorillonite with about 1.9 nm of interlayer spacing in height, about 5-10 microns of an average particle size and about 1.90 g/cc of density; Product name CLOICITE 10A manufactured by Southern clay products in USA.

From the results shown in Table 1, it can be found that the physical properties of the polyolefin nanocomposites prepared by Examples 1 and 2 according to the method of the present invention showed equivalent level to those of the polyolefin nanocomposites prepared by Comparative Examples 1 and 3 according to the conventional methods which include the additional use of polyolefin resin modified through a pretreatment step in addition to the use of organically modified nanoclay, and showed improved level as compared to those of the polyolefin nanocomposites prepared by Comparative Examples 2 and 4 according to the conventional methods which only include the use of organically modified nanoclay.

### INDUSTRIAL APPLICABILITY

As seen from the above, by the method for preparing a polyolefin nanocomposite according to the present invention, it is possible to produce polyolefin nanocomposite having superior or at least equivalent properties to the polyolefin nanocomposite prepared by the conventional methods, through a simple, efficient and economic process, because the method of the present invention does not require a pretreatment step for modifying the hydrophilicity of polyolefins which has been used in the conventional methods.

1. A method for preparation of polyolefin nanocomposite comprising a step of mixing polyolefin resin, nanomaterial, monomer for grafting and peroxide to disperse the nanomaterial and graft the monomer simultaneously.

2. The method according to claim 1, wherein the polyolefin resin is at least one selected from the group consisting of ethylene homopolymer resin, ethylene copolymer resin, propylene homopolymer resin, propylene copolymer resin and ethylene-vinylacetate copolymer resin.

3. The method according to claim 1, wherein the nanomaterial is nanoclay.

4. The method according to claim 3, wherein the nanoclay is at least one selected from the group consisting of montmorillonite, hectorite, saponite, nontronite, beidellite, vermiculite and halloysite, and has 1-50 nm of interlayer spacing in height, 1-20 microns of average particle size and 1-3 g/cc of density.

5. The method according to claim 3, wherein the nanoclay is a nanoclay organically modified with amine compound.

6. The method according to claim 1, wherein the monomer for grafting is maleic acid.

7. The method according to claim 1, wherein the polyolefin resin, the nanomaterial, the monomer for grafting and the peroxide are mixed by melt-kneading in the temperature range of 150-250° C.

8. The method according to claim 1, wherein one or more conventional additive is further added to and mixed with the polyolefin resin, the nanomaterial, the monomer for grafting and the peroxide.

9. The method according to claim 2, wherein one or more conventional additive is further added to and mixed with the polyolefin resin, the nanomaterial, the monomer for grafting and the peroxide.

10. The method according to claim 3, wherein one or more conventional additive is further added to and mixed with the polyolefin resin, the nanomaterial, the monomer for grafting and the peroxide.

11. The method according to claim 4, wherein one or more conventional additive is further added to and mixed with the polyolefin resin, the nanomaterial, the monomer for grafting and the peroxide.

12. The method according to claim 5, wherein one or more conventional additive is further added to and mixed with the polyolefin resin, the nanomaterial, the monomer for grafting and the peroxide.

13. The method according to claim 6, wherein one or more conventional additive is further added to and mixed with the polyolefin resin, the nanomaterial, the monomer for grafting and the peroxide.

14. The method according to claim 7, wherein one or more conventional additive is further added to and mixed with the polyolefin resin, the nanomaterial, the monomer for grafting and the peroxide.
